(19) United States
(12) Patent Application Publication
(10) Pub. No.: US 2020/0272810 A1
(43) Pub. Date: Aug. 27, 2020

(54) RESPONSE APPARATUS AND RESPONSE METHOD

(71) Applicants: Hitachi, Ltd., Tokyo (JP); The University of Tokyo, Tokyo (JP)

(72) Inventors: Yasuhiro ASA, Tokyo (JP); Takashi NUMATA, Tokyo (JP); Kaori KARASAWA, Tokyo (JP); Takaaki HASHIMOTO, Tokyo (JP)

(21) Appl. No.: 16/713,228

(22) Filed: Dec. 13, 2019

(30) Foreign Application Priority Data
Feb. 26, 2019 (JP) 2019-032335

(51) Int. Cl. G06K 9/00; G06T 7/70; G06T 11/00; G06F 3/14; B25J 11/00

(52) U.S. Cl. CPC G06K 9/00302; G06T 7/70; G06T 2207/30201; G06F 3/14; B25J 11/0015; G06T 11/00

(57) ABSTRACT

A response apparatus includes a processor that executes a program, and is connected to an acquisition device that acquires biological data and to a display device. The processor executes a target identification process that identifies a feeling expression target of a user using the response apparatus on the basis of the biological data of the user acquired by the acquisition device, a feeling identification process that identifies a feeling of the user on the basis of facial image data of the user, a determination process that determines a feeling indicated by the image displayed on the display device on the basis of the feeling expression target identified by the target identification process and the feeling of the user identified by the feeling identification process. Image data indicating the feeling determined by the determination process is output to the display device.

### CLAIM OF PRIORITY

The present application claims priority from Japanese patent application JP 2019-032335 filed on Feb. 26, 2019, the content of which is hereby incorporated by reference into this application.

### BACKGROUND OF THE INVENTION

### 1. Field of the Invention

The present invention relates to a response apparatus and a response method for responding to a user.

### 2. Description of the Related Art

JP-2005-258820-A discloses a feeling guidance apparatus for enabling an agent to establish communication influential to a person even if a person's mental state is negative. This feeling guidance apparatus includes mentality detection means detecting a mental state of a person by using at least one of a biological information detection sensor and a person's state detection sensor; situation detection means detecting a situation in which the person is put; and mental state determination means determining whether or not the person's mental state is a state in which the person feels unpleasant on the basis of the person's mental state detected by the mentality detection means, the situation in which the person is put detected by the situation detection means, and duration time of the situation in which the person is put. In a case in which the mental state determination means determines that the person's mental state is the state in which the person feels unpleasant, an agent establishes communication in conformity to the person's mental state.

However, with the conventional technique described above, it is impossible to estimate a target to which a user expresses a feeling; thus, there is a case in which the agent sends an inappropriate response to the user and does not contribute to inducing an action of the user.

### SUMMARY OF THE INVENTION

An object of the present invention is to achieve an improvement in accuracy for a response to a user.

According to one aspect of the invention disclosed in the present application, a response apparatus includes a processor that executes a program, and a storage device that stores the program, and is connected to an acquisition device that acquires biological data and a display device that displays an image. The processor executes a target identification process that identifies a feeling expression target of a user using the response apparatus on the basis of the biological data on the user acquired by the acquisition device, a feeling identification process that identifies a feeling of the user on the basis of facial image data on the user, a determination process that determines a feeling indicated by the image displayed on the display device on the basis of the feeling expression target identified by the target identification process and the feeling of the user identified by the feeling identification process, and a generation process that generates image data indicating the feeling determined by the determination process to output the image data to the display device.

According to a typical embodiment of the present invention, it is possible to achieve an improvement in accuracy for a response to a user. Objects, configurations, and advantages other than those described above will be readily apparent from the description of embodiments given below.

### BRIEF DESCRIPTION OF THE DRAWINGS

FIGS. 1A and 1B are explanatory diagrams each depicting an example of a scene in which a person assumes an angry facial expression;

FIG. 2 is an external view of a response apparatus;

FIG. 3 is a block diagram depicting an example of a hardware configuration of the response apparatus;

FIG. 4 is an explanatory diagram depicting an example of a feeling response model depicted in FIG. 1;

FIG. 5 is a graph indicating a statistical result expressing a user's mood in a case in which a user feeling is joy;

FIG. 6 is a graph indicating a statistical result expressing a user's mood in a case in which the user feeling is sadness;

FIG. 7 is a graph indicating a statistical result expressing a user's mood in a case in which the user feeling is surprise;

FIG. 8 is a graph indicating a statistical result expressing a user's mood in a case in which the user feeling is anger;

FIG. 9 is a block diagram depicting an example of a functional configuration of the response apparatus;

FIG. 10 is a table indicating target identification results;

FIG. 11 is an explanatory diagram depicting an example of calculating a line-of-sight direction;

FIG. 12 is a graph indicating a temporal change of a feeling intensity of a user;

FIG. 13 is an explanatory diagram depicting an example of a first target identification table;

FIG. 14 is an explanatory diagram depicting an example of a second target identification table;

FIG. 15 is an explanatory diagram depicting an example of extracting feature points by a user feeling identification section;

FIG. 16 is an explanatory diagram depicting an example of a facial expression/action identification table;

FIG. 17 is an explanatory diagram depicting an example of a feeling definition table;

FIG. 18 is an explanatory diagram depicting an example of facial images of an agent;

FIG. 19 is a flowchart indicating an example of a response process procedure by the response apparatus;

FIG. 20 is a flowchart depicting an example of a detailed process procedure of a target identification process (Step S1901) depicted in FIG. 19;

FIG. 21 is a flowchart indicating an example of a detailed process procedure of a target identification process (Step S2001) based on user biological data depicted in FIG. 20;

FIG. 22 is a flowchart indicating an example of a detailed process procedure of [Target Identification Process Based on Interaction with User (1)]; and

FIG. 23 is a flowchart indicating an example of a detailed process procedure of [Target Identification Process Based on Interaction with User (2)].

### DESCRIPTION OF THE PREFERRED INVENTION

### <Example of Scene in Which Person Assumes Angry Facial Expression>

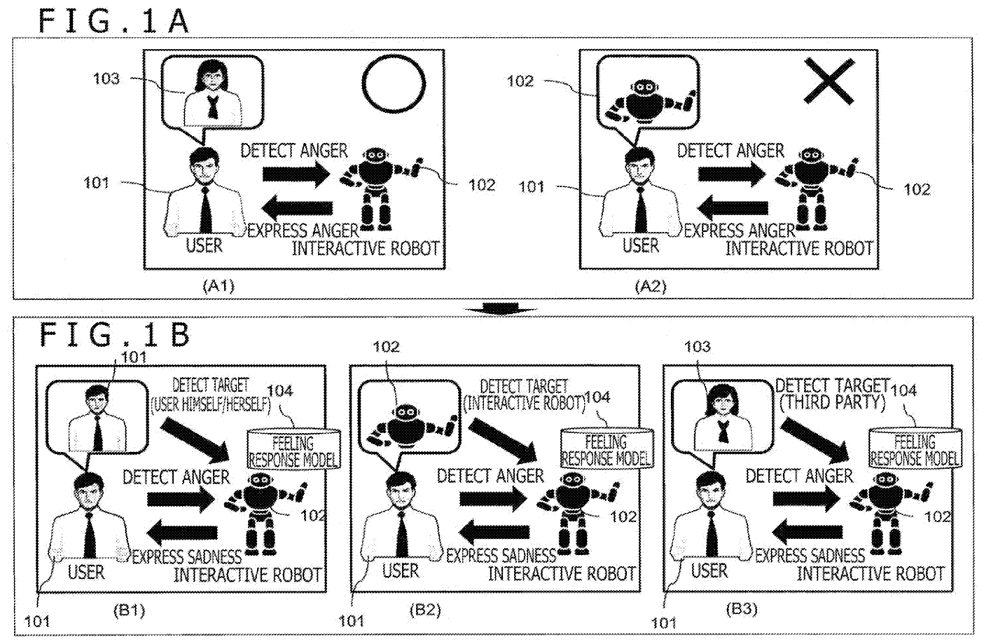

FIGS. 1A and 1B are explanatory diagrams each depicting an example of a scene in which a person assumes an angry facial expression. In FIG. 1A is an example in which an interactive robot 102 does not apply a feeling response model 104, and FIG. 1B is an example in which the interactive robot 102 applies the feeling response model 104. The feeling response model 104 is a model for enabling the interactive robot 102 to express a feeling suited for a user feeling.

In FIG. 1A, (A1) depicts an example in which a target of anger of a user 101 using the interactive robot 102 is a third party 103. Upon detecting the anger of the user 101, the interactive robot 102 imitates an angry facial expression of the user 101 and displays a facial image that similarly indicates anger. Since the interactive robot 102 expresses anger to the third party 103 together with the user 101, the user 101 can feel easy due to an increase of a user's side. In addition, the user 101 can look at the user feeling objectively by looking at the interactive robot 102. Therefore, the interactive robot 102 induces the user 101 to exhibit spontaneous behavior.

In FIG. 1A, (A2) depicts an example in which the target of anger of the user 101 using the interactive robot 102 is the interactive robot 102. The user 101 expresses anger to the interactive robot 102. However, similarly to (A1), upon detecting the anger of the user 101, the interactive robot 102 imitates the angry facial expression and displays the facial image that similarly indicates anger. In this case, the interactive robot 102 rubs the user 101 the wrong way. This reaction causes the user 101 to, for example, get angrier or stop using the interactive robot 102. In this way, the inappropriate response of the interactive robot 102 restrains induction of spontaneous behavior of the user 101.

In FIG. 1B, (B1) depicts an example in which the target of anger of the user 101 using the interactive robot 102 is the user 101 himself/herself. Upon detecting anger of the user 101, the interactive robot 102 determines a feeling to be expressed as a response to the user 101 as sadness by the feeling response model 104, and displays a facial image that indicates the sadness. The interactive robot 102 thereby expresses sadness to the user 101 feeling indignation against himself/herself and restrains the anger of the user 101. The interactive robot 102 can thereby calm down the user 101 and induces the user 101 to exhibit spontaneous behavior.

In FIG. 1B, (B2) depicts an example in which the target of anger of the user 101 using the interactive robot 102 is the interactive robot 102. In this case, similarly to (B1), upon detecting the anger of the user 101, the interactive robot 102 determines a feeling to be expressed as a response to the user 101 as sadness by the feeling response model 104, and displays the facial image that indicates the sadness. The interactive robot 102 thereby expresses sadness to the user 101 feeling indignation against the interactive robot 102 and restrains the anger of the user 101 without imitating the anger of the user 101 and expressing anger as in the case of (A2). The interactive robot 102 can thereby calm down the user 101 and induces the user 101 to exhibit spontaneous behavior.

In FIG. 1B, (B3) depicts an example in which the target of anger of the user 101 using the interactive robot 102 is the third party 103. In this case, similarly to (A1), upon detecting the anger of the user 101, the interactive robot 102 imitates the angry facial expression of the user 101 and displays the facial image that similarly indicates anger. Since the interactive robot 102 expresses anger to the third party 103 together with the user 101, the user 101 can feel easy due to the increase of the user's side. In addition, the user 101 can look at the user feeling objectively by looking at the interactive robot 102. Therefore, the interactive robot 102 induces the user 101 to exhibit spontaneous behavior.

In this way, in the present embodiment, identifying the target to which the user 101 expresses a feeling enables the interactive robot 102 to send an appropriate response to the user 101 to contribute to inducting the user 101 to exhibit spontaneous behavior.

### <External Appearance of Response Apparatus>

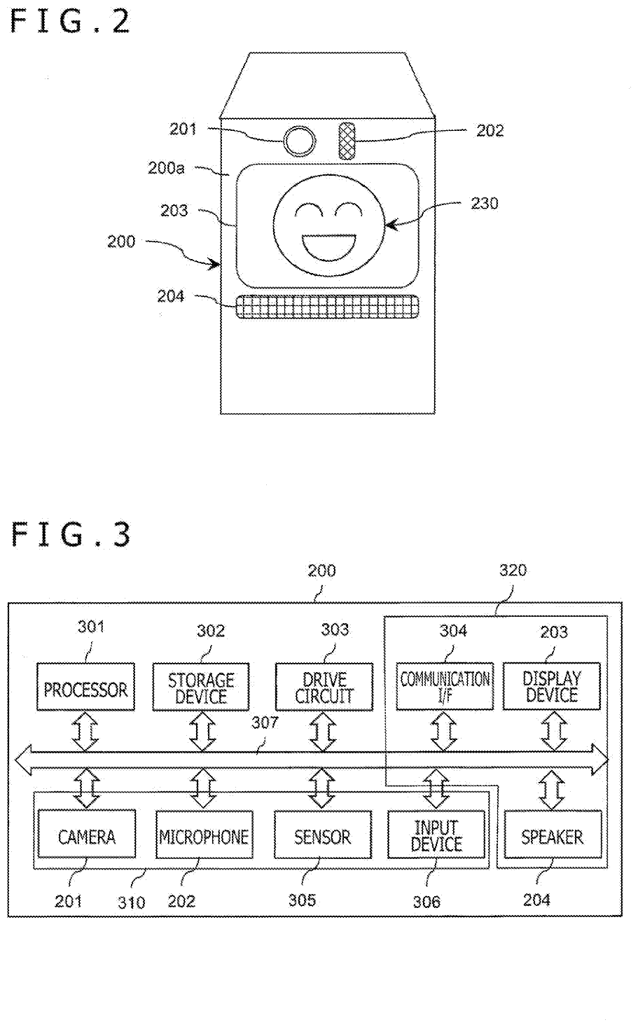

FIG. 2 is an external view of the response apparatus. A response apparatus 200 is either the interactive robot 102 itself or provided in the interactive robot 102. The response apparatus 200 includes a camera 201, a microphone 202, a display device 203, and a speaker 204 on a front face 200a thereof. The camera 201 captures an image of the external appearance of the response apparatus 200 from the front face 200a or an image of a subject coming in the front face 200a. The number of the cameras 201 to be installed is not limited to one but may be two or more such that images of surroundings can be captured. Furthermore, the camera 201 may be a super-wide angle camera or a Time-of-flight (ToF) camera capable of measuring three-dimensional information using time of flight of light.

The microphone 202 is used to input a voice on the front face 200a of the response apparatus 200 to the microphone 202. The display device 203 displays an agent 230 that personifies the interactive robot 102. The agent 230 is a facial image (including a facial video) displayed on the display device 203. The speaker 204 outputs a voice of a speech of the agent 230 or the other voice.

### <Example of Hardware Configuration of Response Apparatus 200>

FIG. 3 is a block diagram depicting an example of a hardware configuration of the response apparatus 200. The response apparatus 200 includes a processor 301, a storage device 302, a drive circuit 303, a communication interface (communication IF) 304, the display device 203, the camera 201, the microphone 202, a sensor 305, an input device 306, and the speaker 204, and these constituent elements of the response apparatus 200 are mutually connected by a bus 307.

The processor 301 controls the response apparatus 200. The storage device 302 serves as a work area of the processor 301. Furthermore, the storage device 302 serves as either a non-transitory or transitory recording medium that stores various programs and data (including a facial image of a target). Examples of the storage device 302 include a Read Only Memory (ROM), a Random Access Memory (RAM), a Hard Disk Drive (HDD), and a flash memory.

The drive circuit 303 controls a driving mechanism of the response apparatus 200 to be driven in response to a command from the processor 301, thereby moving the interactive robot 102. The communication IF 304 is connected to a network to transmit and receive data. The sensor 305 detects a physical phenomenon and a physical state of the target. Examples of the sensor 305 include a range sensor that measures a distance to the target and an infrared ray sensor that detects whether or not the target is present.

The input device 306 is a button or a touch panel touched by the target to input data to the response apparatus 200 through the input device 306. The camera 201, the microphone 202, the sensor 305, and the input device 306 are generically referred to as an “acquisition device 310” that acquires information associated with the target such as biological data. In addition, the communication IF 304, the display device 203, and the speaker 204 are generically referred to as an “output device 320” that outputs information to the target.

It is noted that the drive circuit 303, the acquisition device 310, and the output device 320 may be provided outside of the response apparatus 200, for example, provided in the interactive robot 102 communicably connected to the response apparatus 200 via the network.

### <Example of Feeling Response Model 104>

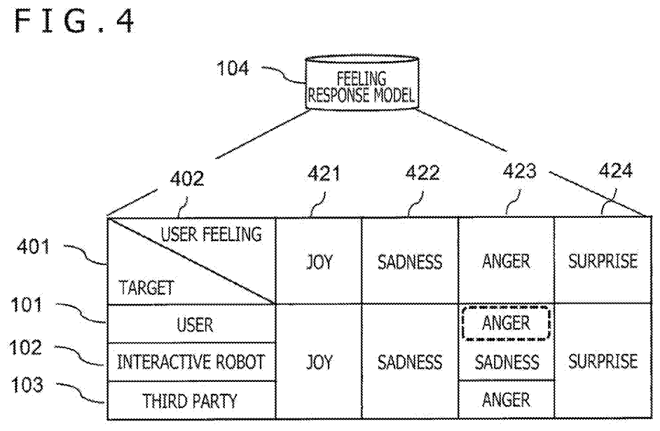

FIG. 4 is an explanatory diagram depicting an example of the feeling response model 104 depicted in FIG. 1. The feeling response model 104 is a model that determines a response feeling of the agent 230 displayed by the interactive robot 102 by a combination of a target 401 and a user feeling 402. The target 401 is a companion to which the user 101 expresses the user feeling 402, and types of the target 401 are classified into, for example, the user 101, the interactive robot 102, and the third party 103. The user feeling 402 is a feeling of the user 101, and types of the user feeling 402 are classified into, for example, joy 421, sadness 422, anger 423, and surprise 424.

In a case in which the user feeling 402 is the joy 421, the sadness 422, and the surprise 424, the response feeling of the agent 230 displayed by the interactive robot 102 is “joy,” “sadness,” and “surprise,” respectively, irrespective of whether the target 401 is the user 101, the interactive robot 102, or the third party 103. In other words, the interactive robot 102 expresses a feeling as if the agent 230 sympathizes with the user 101 as a facial expression of the agent 230.

In a case in which the user feeling 402 is the anger 423 and the target 401 is the third party 103, the response feeling of the agent 230 displayed by the interactive robot 102 is also “anger.” In contrast, in a case in which the user feeling 402 is the anger 423 and the target 401 is the user 101 or the interactive robot 102, the response feeling of the agent 230 displayed by the interactive robot 102 is “sadness.” In a case in which the user feeling 402 is the anger 423, the user 101 is a male, in particular, and the target 401 is the user 101 himself, the response feeling of the agent 230 displayed by the interactive robot 102 is not “sadness” but “anger.”

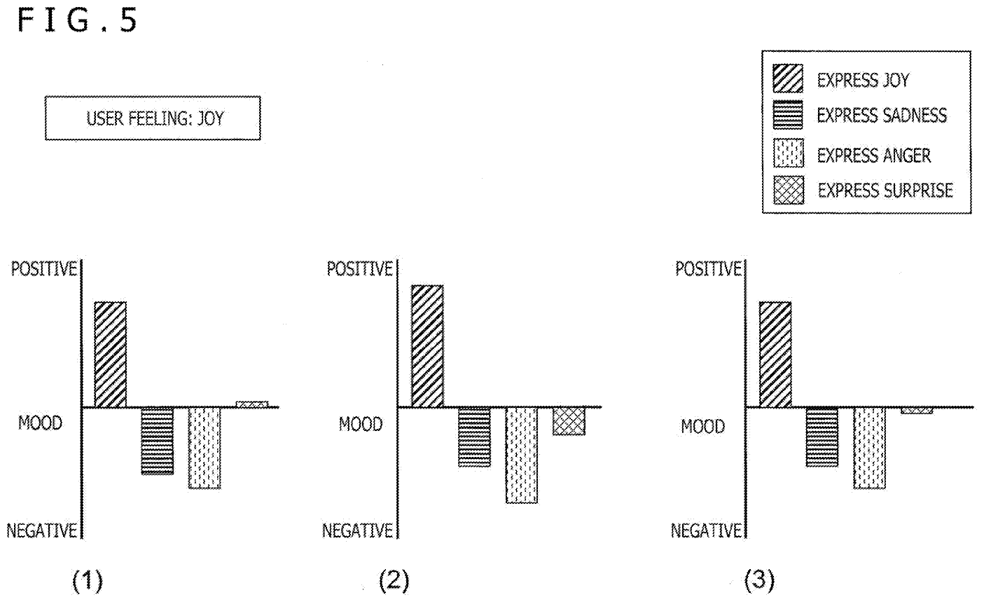

The feeling response model 104 is a model reflective of statistical results depicted in FIGS. 5 to 8 described below. The feeling response model 104 is stored in the storage device 302.

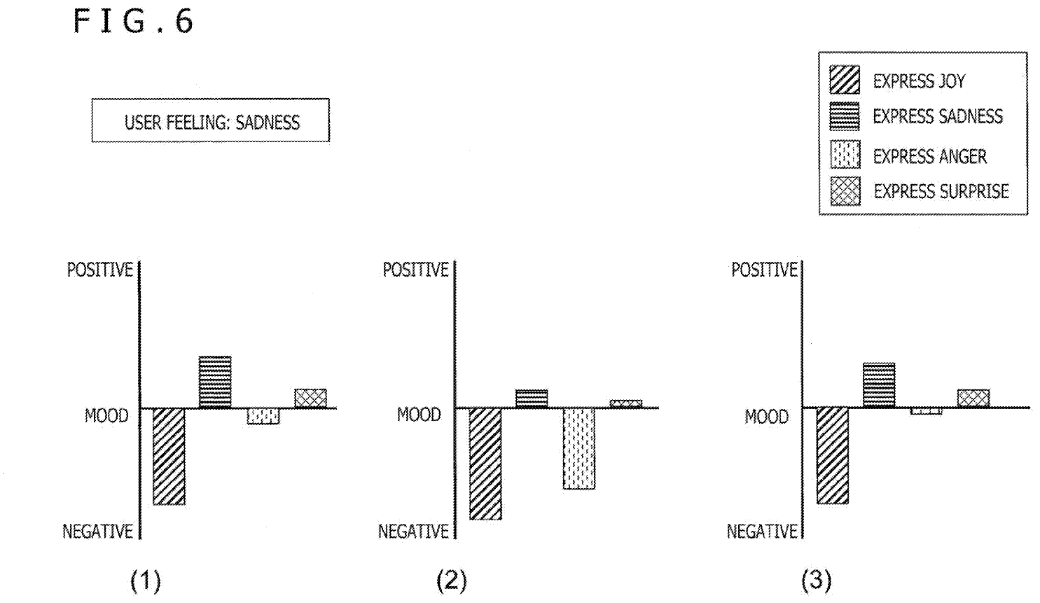

FIG. 5 is a graph indicating a statistical result expressing a mood of the user 101 in a case in which the user feeling 402 is joy. A vertical axis indicates a degree of positiveness (affirmative degree, activeness) and the negativeness (negative degree, inactiveness) (the same goes for FIGS. 6 to 8). A facial expression of the agent 230 that makes the mood of the user 101 most positive is the “joy” irrespective of whether the target 401 is (1) user 101, (2) interactive robot 102, or (3) third party 103.

FIG. 6 is a graph indicating a statistical result expressing the mood of the user 101 in a case in which the user feeling 402 is sadness. The facial expression of the agent 230 that makes the mood of the user 101 most positive is “sadness” irrespective of whether the target 401 is (1) user 101, (2) interactive robot 102, or (3) third party 103.

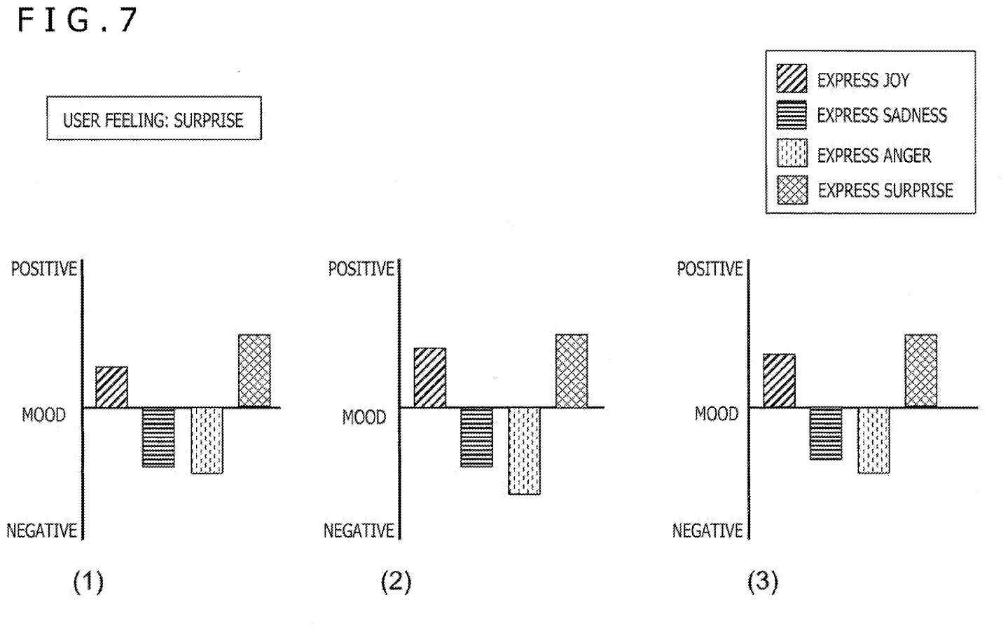

FIG. 7 is a graph indicating a statistical result expressing the mood of the user 101 in a case in which the user feeling 402 is surprise. The facial expression of the agent 230 that makes the mood of the user 101 most positive is “surprise” irrespective of whether the target 401 is (1) user 101, (2) interactive robot 102, or (3) third party 103.

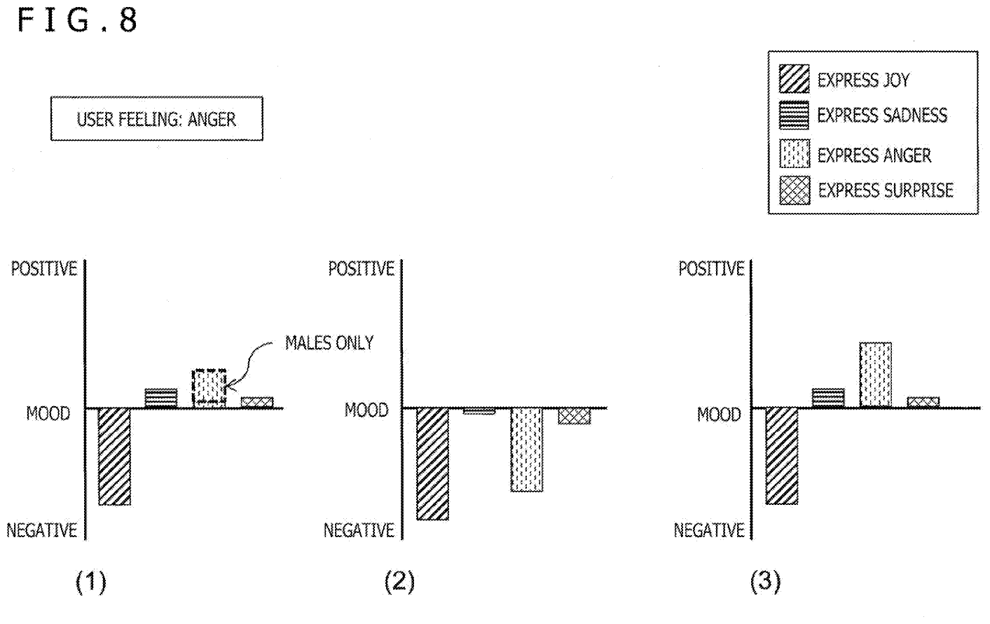

FIG. 8 is a graph indicating a statistical result expressing the mood of the user 101 in a case in which the user feeling 402 is anger. In a case in which the target 401 is (1) user 101, the facial expression of the agent 230 that makes the mood of the user 101 most positive is “sadness.” However, in a case in which the user 101 is a male, the facial expression of the agent 230 that makes the mood of the user 101 most positive is “anger.” In a case in which the target 401 is (2) interactive robot 102, the facial expression of the agent 230 that makes the mood of the user 101 most positive is “sadness.” In a case in which the target 401 is (3) third party 103, the facial expression of the agent 230 that makes the mood of the user 101 most positive is “anger.”

### <Example of Functional Configuration of Response Apparatus 200>

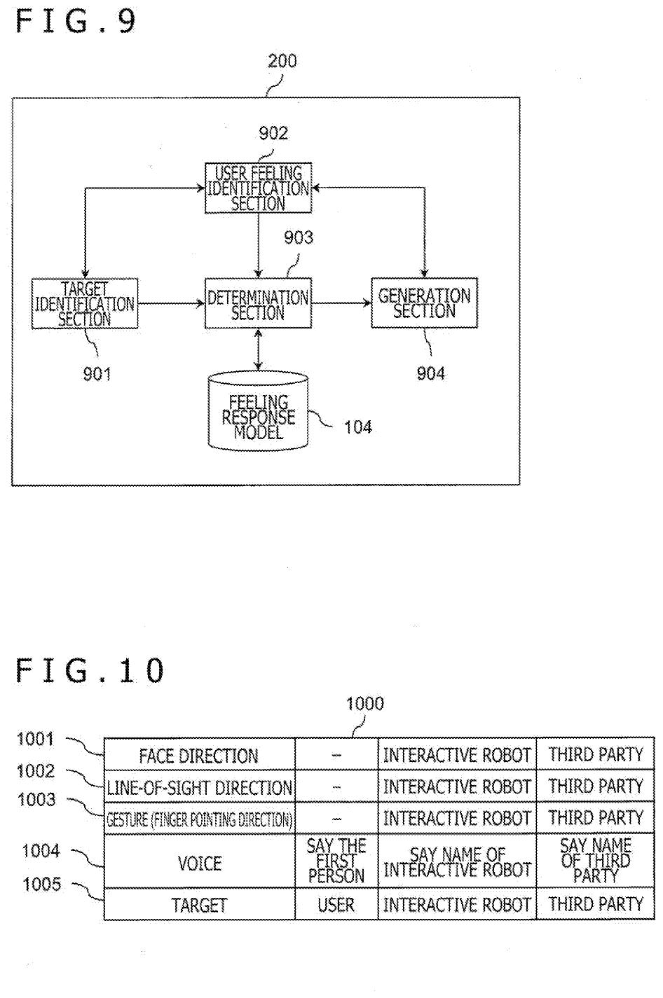

FIG. 9 is a block diagram depicting an example of a functional configuration of the response apparatus 200. The response apparatus 200 has the feeling response model 104, a target identification section 901, a user feeling identification section 902, a determination section 903, and a generation section 904. Specifically, the target identification section 901, the user feeling identification section 902, the determination section 903, and the generation section 904 are functions realized by causing the processor 301 to execute, for example, the program stored in the storage device 302 depicted in FIG. 3.

[Target Identification Process Based on Biological Data about User 101]

The target identification section 901 executes a target identification process for identifying the target 401 to which the feeling of the user 101 is expressed (hereinafter, referred to as “feeling expression target 401”) on the basis of the biological data, acquired by the acquisition device 310, regarding the user 101 using the response apparatus 200. The user 101 is a person whose facial image data is registered in the storage device 302 of the response apparatus 200. It is assumed that the facial image data is facial image data captured by the camera 201 of the response apparatus 200. A user name (which is not necessarily a real name) and voice data on the user name besides the facial image data may be registered in the storage device 302.

The biological data includes image data on the face of the user 101, image data on the hand of the user 101, and voice data on a speech of the user 101. The image data is assumed as data captured by the camera 201 installed in front of the interactive robot 102 in a case in which the interactive robot 102 faces the user 101.

FIG. 10 is a table 1000 indicating identification results of the target 401. The target identification section 901 identifies the target 401 as any of the user 101, the interactive robot 102, and the third party 103 by identifying, from the biological data, a face direction 1001 that is the orientation of the face of the user 101, a line-of-sight direction 1002 of the user 101, a gesture of the hand (finger pointing direction) 1003 of the user, or a voice 1004 of the user 101.

Specifically, in a case, for example, in which the biological data is the facial image data on the user 101, the target identification section 901 identifies the feeling expression target 401 of the user 101 by identifying the face direction 1001 of the user 101 on the basis of the facial image data on the user 101. For example, the target identification section 901 extracts three feature points indicating inner corners of both eyes and a tip of the nose, and identifies the face direction 1001 of the user 101 from a relative position relation among the three feature points. The target identification section 901 then calculates a certainty factor per target 401 on the basis of the face direction 1001.

In a case in which the face direction 1001 is, for example, a front direction, the target identification section 901 determines that the user 101 is looking at the agent 230 of the interactive robot 102. Therefore, the target identification section 901 calculates 100% as a certainty factor that the feeling expression target 401 of the user 101 is the interactive robot 102, and calculates 0% as a certainty factor that the feeling expression target 401 of the user 101 is the third party 103. The target identification section 901 calculates both certainty factors such that a total of the factors is 100%.

On the other hand, as the face direction 1001 deviates more greatly from the front direction in a horizontal direction, the target identification section 901 determines that a probability that the third party 103 is present in the face direction 1001 is higher. Therefore, as the face direction 1001 deviates more greatly from the front direction in the horizontal direction, the target identification section 901 sets lower the certainty factor that the feeling expression target 401 of the user 101 is the interactive robot 102 and sets higher the certainty factor that the feeling expression target 401 of the user 101 is the third party 103. The target identification section 901 then identifies the interactive robot 102 or the third party 103 at the higher certainty factor as the feeling expression target 401 of the user 101. It is noted that both certainty factors of 50% indicate that the target identification section 901 is unable to identify the target 401.

It is noted that the target identification section 901 may determine whether the third party 103 is present from a detection result by the infrared ray sensor that is one example of the sensor 305. For example, only in a case in which the infrared ray sensor detects the presence of a person other than the user 101, the target identification section 901 may calculate the certainty factor that the feeling expression target 401 of the user 101 is the third party 103.

Furthermore, in a case in which the infrared ray sensor is used and the infrared ray sensor does not detect the presence of a person other than the user 101, the probability that the user 101 does not pay attention to anyone is higher as the face direction 1001 deviates more greatly from the front direction. In this case, as the face direction 1001 deviates more greatly from the front direction, the target identification section 901 may set lower the certainty factor that the feeling expression target 401 of the user 101 is the interactive robot 102 and set higher the certainty factor that the feeling expression target 401 of the user 101 is the third party 103. Also in this case, the target identification section 901 similarly calculates both certainty factors such that the total of the factors is 100%. The target identification section 901 then identifies the interactive robot 102 or the third party 103 at the higher certainty factor as the feeling expression target 401 of the user 101. It is noted that both certainty factors of 50% indicate that the target identification section 901 is unable to identify the target 401.

Moreover, in a case in which the biological data is the facial image data on the user 101, the target identification section 901 may identify the feeling expression target 401 of the user 101 by identifying the line-of-sight direction 1002 of the user 101 on the basis of the facial image data on the user 101. The target identification section 901 may identify the line-of-sight direction 1002 of the user 101 from image data on the eye (which may be any of the right and left eyes) of the user 101.

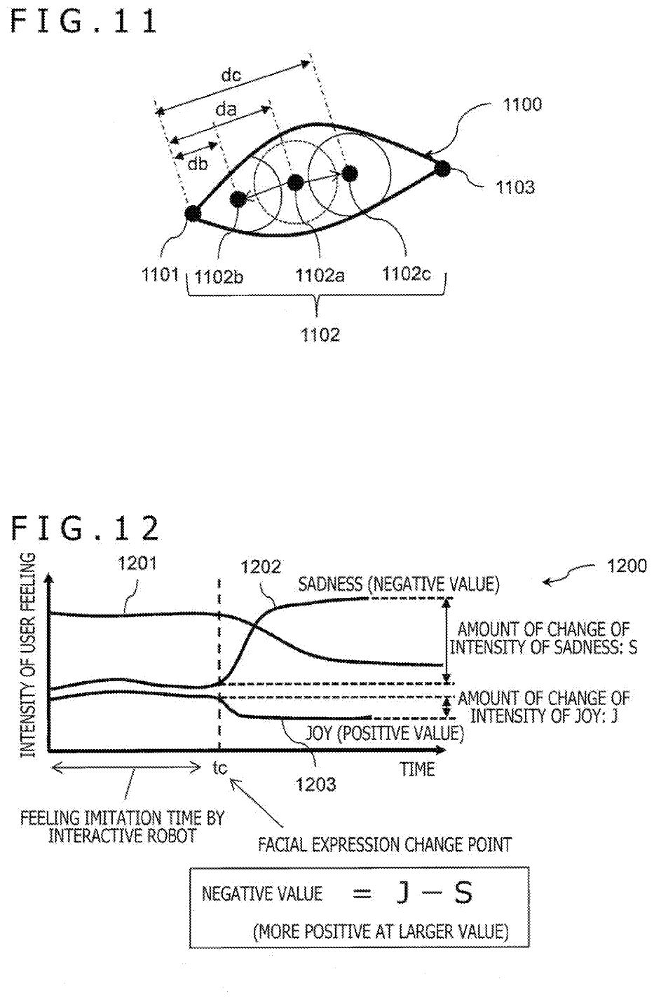

FIG. 11 is an explanatory diagram depicting an example of calculating the line-of-sight direction 1002. FIG. 11 depicts image data 1100 on the left eye of the user 101. The target identification section 901 extracts an inner corner 1101 of the left eye (or may extract a tail of the left eye 1103) and a central position 1102 of an iris from the image data 1100 on the left eye of the user 101 as feature points, and calculates a distance d between the inner corner 1101 of the left eye and the central position 1102 of the iris.

A central position 1102a of the iris in a case in which the line-of-sight direction 1002 of the left eye is the front direction is assumed, for example, as an intermediate point between the inner corner 1101 and the tail 1103 of the left eye. In this case, the distance d between the inner corner 1101 and the central position 1102a of the iris is assumed as a distance da. In the case of d=da, the target identification section 901 determines that the line-of-sight direction 1002 is the front direction and calculates 100% as the certainty factor that the feeling expression target 401 of the user is the interactive robot 102, and calculates 0% as the certainty factor that the feeling expression target 401 of the user 101 is the third party 103. The target identification section 901 calculates both certainty factors such that a total of the factors is 100%.

When the user 101 turns the user's eyes on the right side of the front, the central position 1102a of the iris moves rightward (the central position 1102 of the iris after movement is assumed as 1102b). In this case, the distance d is db (<da). Likewise, when the user 101 turns the user's eyes on the left side of the front, the central position 1102a of the iris moves leftward (the central position 1102 of the iris after movement is assumed as 1102c). In this case, the distance d is dc (>da).

In this way, the target identification section 901 determines that the line-of-sight direction 1002 of the user 101 deviates rightward from the front when the distance d is smaller than da, and that the user 101 deviates leftward from the front when the distance d is larger than da. Therefore, the target identification section 901 determines that the probability that the user 101 is looking at the agent 230 of the interactive robot 102 is higher as the line-of-sight direction 1002 of the user 101 deviates from the front more greatly in the horizontal direction.

Therefore, the target identification section 901 sets lower the certainty factor that the feeling expression target 401 of the user 101 is the interactive robot 102 and higher the certainty factor that the feeling expression target 401 of the user 101 is the third party 103 as the distance d deviates more greatly from the distance da. In this case, the target identification section 901 calculates both the certainty factors such that a total of the factors is 100%. The target identification section 901 then identifies the interactive robot 102 or the third party 103 at the higher certainty factor as the feeling expression target 401 of the user 101. It is noted that both certainty factors of 50% indicate that the target identification section 901 is unable to identify the target 401.

It is noted that the target identification section 901 may determine whether the third party 103 is present from the detection result by the infrared ray sensor that is one example of the sensor 305. For example, only in the case in which the infrared ray sensor detects the presence of a person other than the user 101, the target identification section 901 may calculate the certainty factor that the feeling expression target 401 of the user 101 is the third party 103.

Furthermore, in the case in which the infrared ray sensor is used and the infrared ray sensor does not detect the presence of a person other than the user 101, the probability that the user 101 does not pay attention to anyone is higher as the line-of-sight direction 1002 of the user 101 deviates more greatly from the front direction. In this case, as the line-of-sight direction 1002 more greatly deviates from the front direction, the target identification section 901 may set lower the certainty factor that the feeling expression target 401 of the user 101 is the interactive robot 102 and set higher the certainty factor that the feeling expression target 401 of the user 101 is the third party 103. also in this case, the target identification section 901 similarly calculates both certainty factors so that the total of the factors is 100%. The target identification section 901 then identifies the interactive robot 102 or the third party 103 at the higher certainty factor as the feeling expression target 401 of the user 101. It is noted that two certainty factors of 50% indicate that the target identification section 901 is unable to identify the target 401.

Moreover, in a case in which the biological data is the image data on the hand of the user 101, the target identification section 901 may identify the feeling expression target 401 of the user 101 by identifying the finger pointing direction 1003 of the user 101 on the basis of the image data on the hand of the user 101. Specifically, the target identification section 901, for example, acquires the image data on the hand of the user 101 with the ToF camera that is one example of the camera 201, and identifies the finger pointing direction 1003 of, for example, a forefinger using a learning model of deep learning. The target identification section 901 then calculates the certainty factor per target 401 on the basis of the finger pointing direction 1003.

As a result, in a case in which the finger pointing direction 1003 is the front direction, the target identification section 901 determines that the user 101 is pointing a finger at the agent 230 of the interactive robot 102. Therefore, the target identification section 901 calculates 100% as the certainty factor that the feeling expression target 401 of the user 101 is the interactive robot 102, and calculates 0% as the certainty factor that the feeling expression target 401 of the user 101 is the third party 103. The target identification section 901 calculates both certainty factors such that the total of the factors is 100%.

In contrast, as the finger pointing direction 1003 deviates more greatly from the front direction, the target identification section 901 determines that the probability that the third party 103 is present in the finger pointing direction 1003 is higher. Therefore, as the finger pointing direction 1003 deviates more greatly from the front direction in the horizontal direction, the target identification section 901 sets lower the certainty factor that the feeling expression target 401 of the user 101 is the interactive robot 102 and sets higher the certainty factor that the feeling expression target 401 of the user 101 is the third party 103. The target identification section 901 then identifies the interactive robot 102 or the third party 103 at the higher certainty factor as the feeling expression target 401 of the user 101. It is noted that both certainty factors of 50% indicate that the target identification section 901 is unable to identify the target 401.

It is noted that the target identification section 901 may determine whether the third party 103 is present from the detection result by the infrared ray sensor that is one example of the sensor 305. For example, only in the case in which the infrared ray sensor detects the presence of a person other than the user 101, the target identification section 901 may calculate the certainty factor that the feeling expression target 401 of the user 101 is the third party 103.

Furthermore, in a case in which the biological data is the voice data, the target identification section 901 may identify the feeling expression target 401 of the user 101 on the basis of voice recognition. Specifically, the target identification section 901 determines first, for example, whether or not the acquired voice data is voice data on the user 101 by the voice recognition on the basis of the voice data on the user 101 registered in advance.

In a case of determining that the acquired voice data is the voice data from the user 101 and a recognition result of the voice data from the user 101 is the first person such as “I,” “my,” and “me” as indicated in the voice 1004 of FIG. 10, the target identification section 901 identifies the feeling expression target 401 of the user 101 is the user 101 (in this case, it is estimated that the user 101 says to himself/herself). Furthermore, in a case in which the recognition result of the voice data from the user 101 indicates a name of the interactive robot 102 (or agent 230), the target identification section 901 identifies the feeling expression target 401 of the user 101 is the interactive robot 102. Moreover, in a case in which the recognition result of the voice data from the user 101 is a name of the third party 103, the target identification section 901 identifies the feeling expression target 401 of the user 101 is the third party 103.

[Target Identification Process Based on Interaction with User 101 (1)]

Furthermore, the target identification section 901 may identify the target 401 by an interaction with the user 101. Specifically, the target identification section 901 identifies the feeling expression target 401 of the user 101 on the basis of, for example, a change in the user feeling 402. In this case, the interactive robot 102 captures an image of the facial expression of the user 101 with the camera 201 and identifies the user feeling 402 by the user feeling identification section 902. The interactive robot 102 causes the generation section 904 to generate facial image data on the agent 230 that expresses the user feeling 402 identified by the user feeling identification section 902, to output the facial image data to the display device 203, and to display a facial image of the agent 230 that expresses the user feeling 402 on the display device 203.

In this case, the user feeling identification section 902 calculates a feeling intensity per user feeling 402. The feeling intensity indicates a likelihood of the user feeling 402 estimated from the facial expression of the user 101. The user feeling identification section 902 may calculate the feeling intensity by applying a facial action coding system (FACS) to be described later. Furthermore, the user feeling identification section 902 may apply a learning model of deep learning learned by applying a learning data set of the facial image data and a correct answer label of the user feeling 402 to a convolutional neural network, to the convolutional neural network. In this case, the user feeling identification section 902 inputs the facial image data on the user 101 into the convolutional neural network, and may determine an output value from the convolutional neural network (for example, an output value from a SoftMax function) as the feeling intensity.

In a case in which the feeling intensity of the user feeling 402 that is the anger 423 continues to be higher than those of the other user feelings 402 and the anger 423 then changes to the other user feeling 402, the user feeling identification section 902 calculates a positive negative degree as an evaluation value that indicates the change in the user feeling 402. The positive negative degree is an index value that indicates the positiveness (affirmative degree, activeness) and the negativeness (negative degree, inactiveness) of the user feeling 402, and is a difference between an amount of change J of the feeling intensity of the joy 421 that represents the positiveness and an amount of change S of the feeling intensity of the sadness 422 that represents the negativeness. The user feeling 402 is more positive as the positive negative degree is larger, and is more negative as the positive negative degree is smaller.

FIG. 12 is a graph indicating a temporal change of the feeling intensity of the user 101. FIG. 12 indicates an intensity waveform 1201 of the anger 423, an intensity waveform 1202 of the sadness 422, and an intensity waveform 1203 of the joy 421 in a case in which the user feeling 402 is the anger 423, the interactive robot 102 imitates the anger 423, and the user feeling 402 changes from the anger 423 to the sadness 422. Assuming that the user feeling 402 changes from the anger 423 to the sadness 422 at a facial expression change point tc, the feeling intensities 1201 and 1203 of the anger 423 and the joy 421 fall and the feeling intensity 1201 of the sadness 422 rises at the facial expression change point tc. The positive negative degree in this case is a negative value since the amount of change S of the feeling intensity 1202 of the sadness 422 is greater than the amount of change J of the feeling intensity 1203 of the joy 421.

More specifically, in a case in which an absolute value of the positive negative degree is equal to or greater than a threshold and the positive negative degree is a positive value, the target identification section 901 determines that the user feeling 402 is in a positive state in which the user feeling 402 changes from the anger 423 to the joy 421.

Conversely, in a case in which the absolute value of the positive negative degree is equal to or greater than the threshold and the positive negative degree is a negative value, the target identification section 901 determines that the user feeling 402 is in a negative state in which the user feeling 402 changes from the anger 423 to the sadness 422. It is noted that the target identification section 901 determines that the anger 423 that is the user feeling 402 continues in a state in which the feeling intensity 1201 of the anger 423 is higher than those of the other user feelings 402 in a case in which the absolute value of the positive negative degree is not equal to or greater than the threshold.

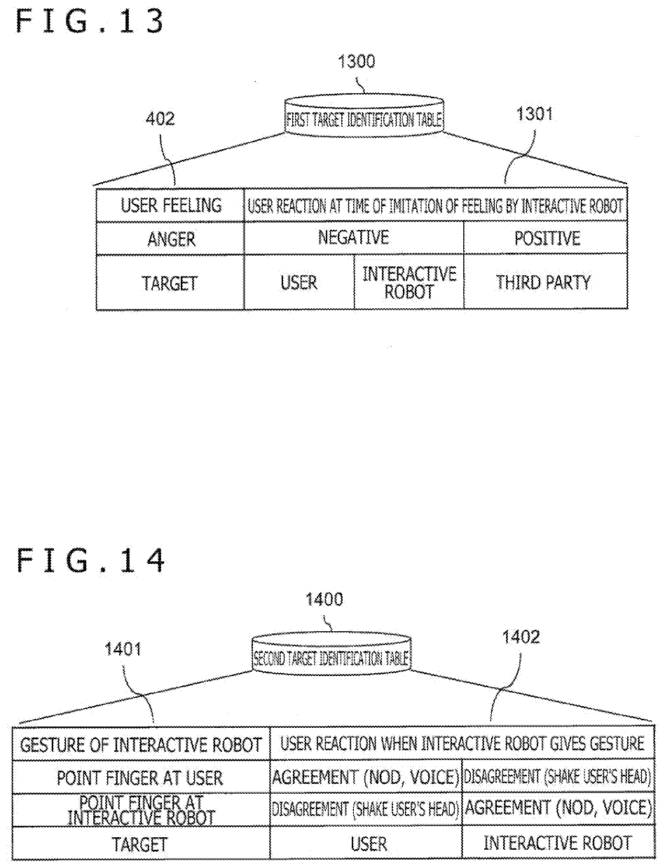

FIG. 13 is an explanatory diagram depicting an example of a first target identification table. The first target identification table is a table for identifying the target 401 in response to a user reaction 1301 when the interactive robot 102 imitates the anger 423 (hereinafter, simply referred to as “user reaction 1301”) in the case in which the user feeling 402 is the anger 423. Types of the user reaction 1301 include a positive reaction and a negative reaction, and it is determined whether the user reaction 1301 is positive or negative by the positive negative degree. It is assumed, for example, that a threshold of the positive negative degree is zero. It is determined that the user reaction 1301 is positive in a case in which the positive negative degree is equal to or greater than zero, and is a negative in a case in which the positive negative degree is smaller than zero. In the case in which the user reaction 1301 is positive, the target identification section 901 determines that the target 401 is the third party 103.

Conversely, in the case in which the user reaction 1301 is negative, the target identification section 901 determines that the target 401 is the user 101 or the interactive robot 102. In this case, the target identification section 901 executes a target identification process based on a dialog.

### [Target Identification Process Based on Dialog]

The target identification section 901 identifies the target 401 as either the user 101 or the interactive robot 102 by a dialog with the user 101. Specifically, the target identification section 901 displays, for example, a character string that urges the user 101 to reply to the interactive robot 102 by voice output or the display device 203. The target identification section 901 determines that the target 401 is the interactive robot 102 in a case of recognizing that the user 101 does not reply or that a content of a voice from the user 101 is that the user 101 denies the dialog with the interactive robot 102 by the voice recognition. In contrast, the target identification section 901 identifies the target 401 as the user 101 in a case of recognizing that the content of the voice from the user 101 is that the user 101 affirms the dialog with the interactive robot 102.

[Target Identification Process Based on Interaction with User 101 (2)]

Furthermore, the target identification section 901 identifies the feeling expression target 401 of the user 101 as either the user 101 or the interactive robot 102 on the basis of data indicative of a user reaction to a finger pointing image acquired by the acquisition device 310 as a result of display of the finger pointing image indicating finger pointing at either the user 101 or the interactive robot 102 on the display device 203.

Specifically, the generation section 904 generates, for example, facial image data on the agent 230 indicating finger pointing at the user 101 or facial image data on the agent 230 indicating finger pointing at the interactive robot 102 (or agent 230) itself as a gesture of the interactive robot 102, and displays a facial image of the agent 230 on the display device 203 of the interactive robot 102.

As a result of displaying the facial image of the agent 230 and causing the acquisition device 310 to acquire the facial expression or voice of the user 101 as data indicating the user reaction, the target identification section 901 identifies whether the user reaction is agreement (an action indicating a nod or a voice meaning the agreement) or disagreement (an action of shaking the user's head or a voice meaning the disagreement).

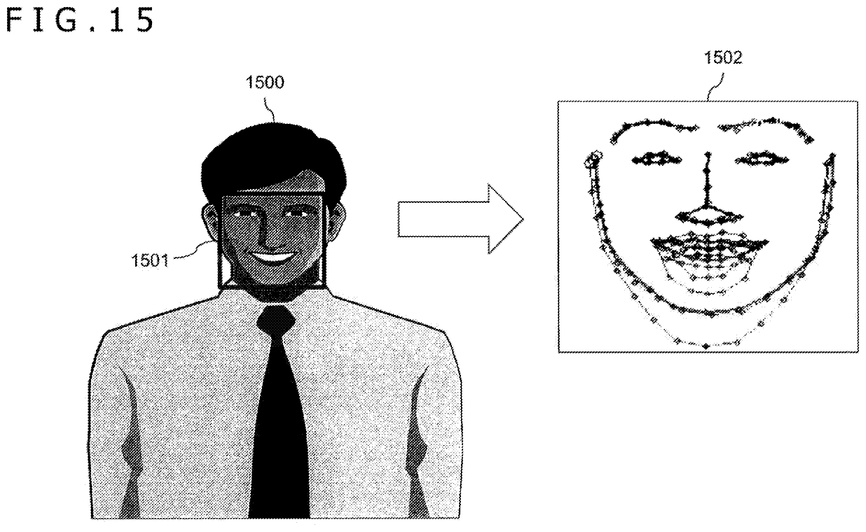

FIG. 14 is an explanatory diagram depicting an example of a second target identification table. The target identification section 901 identifies the target 401 as the user 101 if a content of a gesture 1401 of the interactive robot 102 is that the facial image of the agent 230 is indicative of finger pointing at the user 101 and a user reaction 1402 when the interactive robot 102 gives a gesture (hereinafter, simply referred to as “user reaction 1402”) indicates agreement. The target identification section 901 identifies the target 401 as the interactive robot 102 if the content of the gesture 1401 of the interactive robot 102 is that the facial image of the agent 230 is indicative of finger pointing at the user 101 and the user reaction 1402 indicates disagreement.

The target identification section 901 identifies the target 401 as the user 101 if the content of the gesture 1401 of the interactive robot 102 is that the facial image of the agent 230 is indicative of finger pointing at the interactive robot 102 (or agent 230) itself and the user reaction 1402 indicates disagreement. The target identification section 901 identifies the target 401 as the interactive robot 102 if the content of the gesture 1401 of the interactive robot 102 is that the facial image of the agent 230 is indicative of finger pointing at the interactive robot 102 (or agent 230) itself and the user reaction 1402 indicates agreement.

An example in which the facial image of the agent 230 indicative of finger pointing at the user 101 or the interactive robot 102 (or agent 230) is used as the gesture 1401 of the interactive robot 102 has been described above. Alternatively, the target identification section 901 may control the interactive robot 102 to strike a pose of pointing a finger at the user 101 or the interactive robot 102 (or agent 230) itself as the gesture 1401 of the interactive robot 102 by moving an arm and a finger of the interactive robot 102 by drive control from the drive circuit 303.

It is noted that the target identification section 901 may execute any one of the “Target Identification Processes Based on Interaction with User 101 (1) and (2)” in a case in which the target identification section 901 is unable to identify the target 401 by performing “Target Identification Process Based on Biological Data on User 101.” Alternatively, the target identification section 901 may execute any one of the “Target Identification Processes Based on Interaction with User 101 (1) and (2)” independently of “Target Identification Process Based on Biological Data on User 101.”

The user feeling identification section 902 executes a feeling identification process for identifying the user feeling 402 on the basis of the facial image data on the user 101. Specifically, the user feeling identification section 902, for example, acquires the facial image data on the user 101 with the camera 201, and extracts many feature points, for example, 64 feature points from the facial image data. The user feeling identification section 902 identifies the user feeling 402 by a combination of the 64 feature points and changes thereof.

FIG. 15 is an explanatory diagram depicting an example of extracting the feature points by the user feeling identification section 902. The user feeling identification section 902 acquires image data 1500 on the user 101 and identifies facial image data 1501 on the user 101. The user feeling identification section 902 then extracts feature points from the facial image data 1501 on the user 101 and generates feature point data 1502 by coupling the feature points. Corresponding unique numbers are assigned to the feature points. The user feeling identification section 902 identifies the user feeling 402 using the feature point data 1502, a facial expression/action identification table 1600, and a feeling definition table 1700.

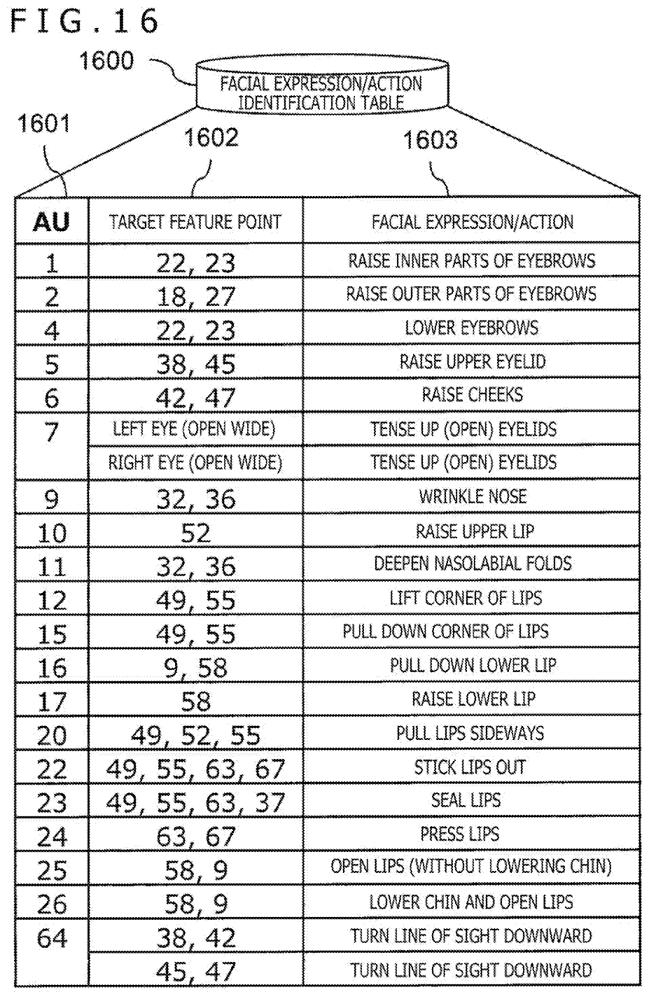

FIG. 16 is an explanatory diagram depicting the example of the facial expression/action identification table. The facial expression/action identification table 1600 is a table in which a target feature point 1602 and a facial expression/action 1603 are made to correspond to an action unit (AU) number 1601. The facial expression/action identification table 1600 is stored in the storage device 302. The target feature point 1602 is a combination of specific feature points. The facial expression/action 1603 is a minimum unit of a facial expression/action anatomically independent and visually identifiable. For example, the target feature point 1602 in an entry with the AU number 1601 of “1” is “22” and “23,” and the facial expression/action 1603 of this target feature point 1602 is “raise inner parts of eyebrows.”

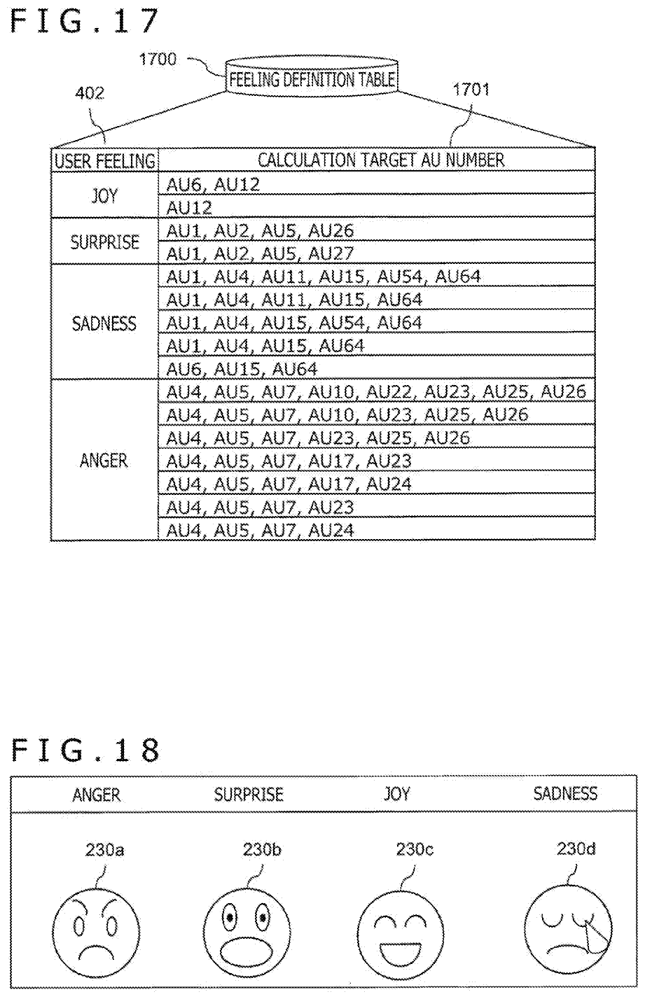

FIG. 17 is an explanatory diagram depicting an example of the feeling definition table. The feeling definition table 1700 is a table in which the user feeling 402 is made to correspond to a calculation target AU number 1701. The feeling definition table 1700 is stored in the storage device 302. The calculation target AU number 1701 is a combination of one or more AU numbers 1601 used to calculate the feeling intensity of the user feeling 402. In FIG. 17, the feeling intensity of the joy 421 is calculated on the basis of two kinds of calculation target AU numbers 1701, that of the surprise 424 is calculated on the basis of two kinds of calculation target AU numbers 1701, that of the sadness 422 is calculated on the basis of five kinds of calculation target AU numbers 1701, and that of the anger 423 is calculated on the basis of seven kinds of calculation target AU numbers 1701.

The user feeling identification section 902 calculates the feeling intensities for each of a plurality of calculation target AU numbers 1701 per user feeling 402. The user feeling identification section 902 calculates statistics of the plurality of calculated feeling intensities per user feeling 402. The statistics are, for example, at least one of an average value, a maximum value, a minimum value, a median value of the plurality of calculated feeling intensities. The user feeling identification section 902 identifies the user feeling 402 having maximum statistics among the statistics of the feeling intensities calculated for the user feelings 402 from among the user feelings 402, and outputs the identified user feeling 402 to the determination section 903.

The determination section 903 executes a determination process for determining the response feeling of the agent 230 indicated by a facial image displayed on the display device 203 on the basis of the feeling expression target 401 identified by the target identification section 901 and the user feeling 402 identified by the user feeling identification section 902. Specifically, the determination section 903, for example, refers to the feeling response model 104, and determines the response feeling of the agent 230 corresponding to the feeling expression target 401 identified by the target identification section 901 and the user feeling 402 identified by the user feeling identification section 902.

Furthermore, the determination section 903 may determine the response feeling of the agent 230 indicated by the facial image of the agent 230 displayed on the display device 203 on the basis of the gender of the user 101. In a case in which the gender of the user 101 is registered in advance in the storage device 302 by the user 101 using the input device 306, the determination section 903 may determine the response feeling of the agent 230 in response to the gender of the user 101.

For example, in a case in which the gender is not applied, the target 401 is the user 101, and the user feeling 402 is the anger 423, the determination section 903 determines the response feeling of the agent 230 as “sadness.” In a case in which the gender is applied, the gender of the user 101 is a male, the target 401 is the user 101, and the user feeling 402 is the anger 423, the determination section 903 determines the response feeling of the agent 230 as “anger.”

Moreover, the determination section 903 may apply the learning model of deep learning learned by applying the learning data set of the facial image data and the correct answer label to the convolutional neural network, to the convolutional neural network. In this case, the determination section 903 inputs the facial image data 1501 on the user 101 to the convolutional neural network, and applies an output value from the convolutional neural network as a determination result of the gender.

The generation section 904 executes a generation process for generating the facial image data on the agent 230 indicating the response feeling determined by the determination section 903 and outputting the facial image data to the display device 203. An example of facial images of the agent 230 is depicted in FIG. 18.

FIG. 18 is an explanatory diagram depicting the example of facial images of the agent 230. A facial image 230a of the agent 230 is a facial image expressing “anger,” a facial image 230b of the agent 230 is a facial image expressing “surprise,” a facial image 230c of the agent 230 is a facial image expressing “joy,” and a facial image 230d of the agent 230 is a facial image expressing “sadness.”

### <Example of Response Process Procedure by Response Apparatus 200>

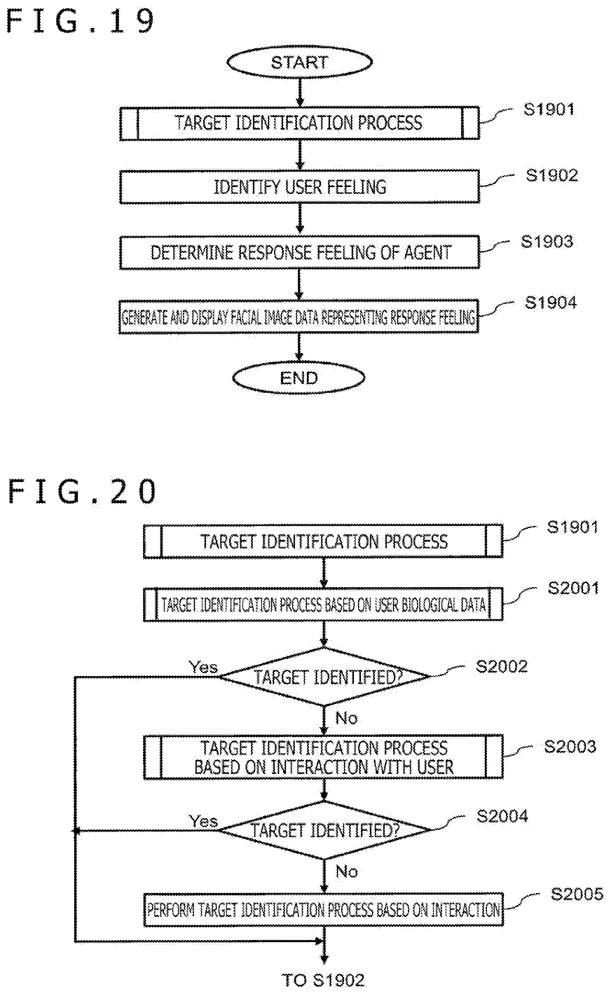

FIG. 19 is a flowchart indicating an example of a response process procedure by the response apparatus 200. The response apparatus 200 executes the target identification process by the target identification section 901 (Step S1901), identifies the user feeling 402 by the user feeling identification section 902 (Step S1902), determines the response feeling of the agent 230 by the determination section 903 (Step S1903), and generates the facial image data representing the determined response feeling of the agent 230 and displays the facial image on the display device 203 (Step S1904).

### <Target Identification Process (S1901)>

FIG. 20 is a flowchart indicating an example of a detailed process procedure of the target identification process (Step S1901) depicted in FIG. 19. The response apparatus 200 executes the “Target Identification Process Based on Biological Data on User 101” described above (Step S2001). The response apparatus 200 determines whether or not the response apparatus 200 has been able to identify the target 401 in Step S2001 (Step S2002). Ina case in which the response apparatus 200 has been able to identify the target 401 (Step S2002: Yes), the process goes to Step S1902.

In contrast, in a case in which the response apparatus 200 has not been able to identify the target 401 (Step S2002: No), the response apparatus 200 executes either “Target Identification Process Based On Interaction With User 101 (1)” or “Target Identification Process Based on Interaction With User 101 (2) ” described above (Step S2003). In a case in which the response apparatus 200 has been able to identify the target 401 (Step S2004: Yes), the process goes to Step S1902.

In contrast, in a case in which the response apparatus 200 has not been able to identify the target 401 (Step S2004: No), the response apparatus 200 executes the target identification process based on dialog described above (Step S2005). The process then goes to Step S1902. In a case in which the response apparatus 200 executes the “Target Identification Process Based on Interaction with User 101 (2)” in Step S2003, the target 401 is identified. Therefore, the process goes to Step S1902 without executing Steps S2004 and S2005.

### <Target Identification Process Based on Biological Data on User 101 (Step S2001)>

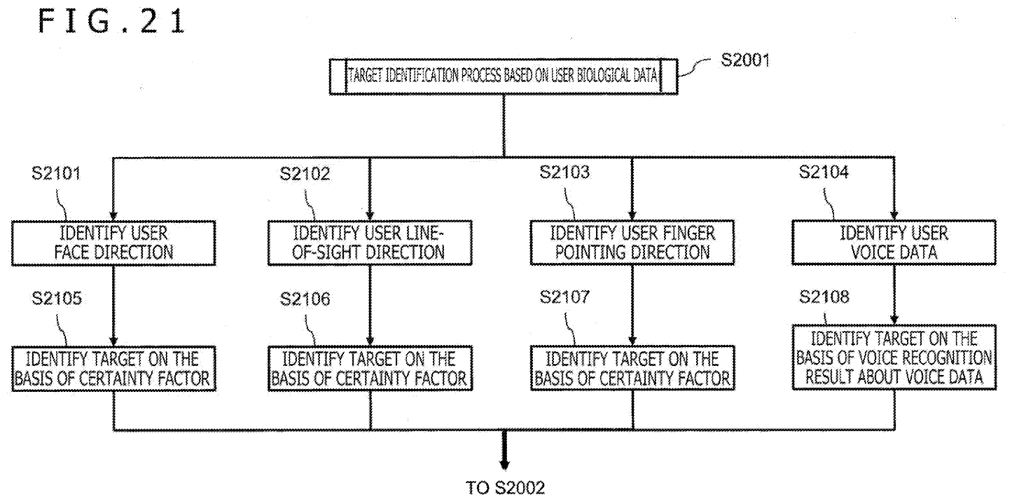

FIG. 21 is a flowchart indicating an example of a detailed process procedure of the target identification process (Step S2001) based on the biological data on the user 101 depicted in FIG. 20. The response apparatus 200 executes any of Steps S2101 to S2104. In a case of acquiring, for example, the facial image data 1501 on the user 101 by the acquisition device 310, the response apparatus 200 identifies the face direction 1001 of the user 101 (Step S2101). In this case, the response apparatus 200 calculates the certainty factor per target 401 from the identified face direction 1001 of the user 101 and identifies the target 401 on the basis of the certainty factor (Step S2105). The process then goes to Step S2002.

Furthermore, in the case of acquiring, for example, the facial image data 1501 on the user 101 by the acquisition device 310, the response apparatus 200 identifies the line-of-sight direction 1002 of the user 101 (Step S2102). In this case, the response apparatus 200 calculates the certainty factor per target 401 from the identified line-of-sight direction 1002 of the user 101 and identifies the target 401 on the basis of the certainty factor (Step S2106). The process then goes to Step S2002.

Moreover, in the case of acquiring, for example, the image data on the hand of the user 101 by the acquisition device 310, the response apparatus 200 identifies the finger pointing direction 1003 of the user 101 (Step S2103). In this case, the response apparatus 200 calculates the certainty factor per target 401 from the identified finger pointing direction 1003 of the user 101 and identifies the target 401 on the basis of the certainty factor (Step S2107). The process then goes to Step S2002.

Furthermore, in the case of acquiring the voice data by the acquisition device 310, the response apparatus 200 identifies that the acquired voice data is the voice data from the user 101 on the basis of voice recognition associated with the voice data on the user 101 registered in advance (Step S2104). In this case, the response apparatus 200 identifies a content of the speech on the basis of the voice recognition result of the identified voice data from the user 101 and identifies the target 401 from the content of the speech (Step S2108). The process then goes to Step S2002.

<Target Identification Process Based on Interaction with User 101>

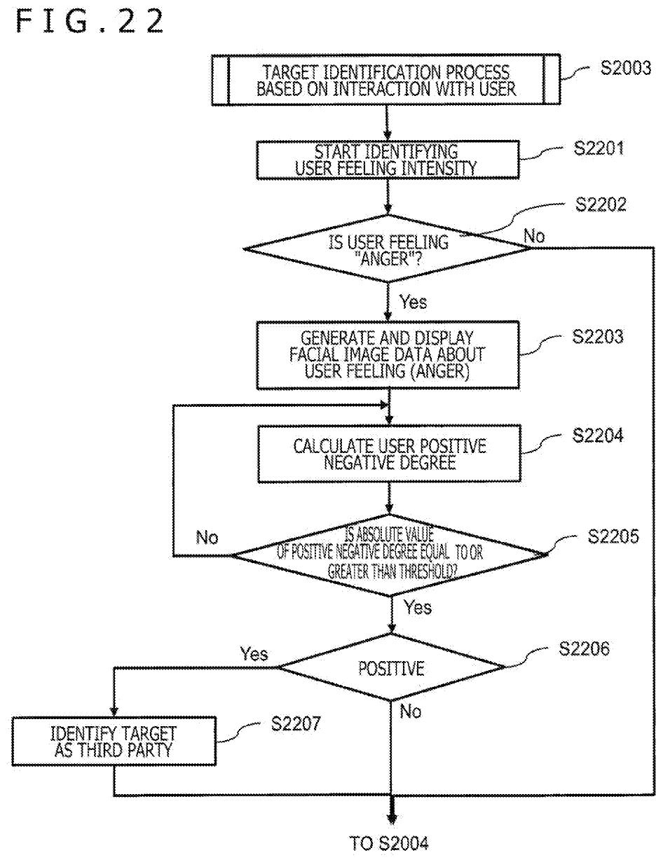

FIG. 22 is a flowchart indicating an example of a detailed process procedure of the [Target Identification Process Based on Interaction with User (1)]. The response apparatus 200 starts identifying the feeling intensity of the user feeling 402 of the user 101 by the user feeling identification section 902 as depicted in FIG. 12 (Step S2201). The response apparatus 200 determines whether or not the user feeling 402 is the anger 423 by the target identification section 901 (Step S2202). Specifically, the response apparatus 200 determines whether or not the user feeling 402 indicating, for example, the maximum feeling intensity is the anger 423. In a case in which the user feeling 402 is not the anger 423 (Step S2202: No), the process goes to Step S2204.

In contrast, in a case in which the user feeling 402 is the anger 423 (Step S2202: Yes), the response apparatus 200 generates the facial image data on the user feeling 402 (anger 423) and displays the facial image 230a of the agent 230 indicating the “anger” on the display device 203 by the generation section 904 (Step S2203). The response apparatus 200 then calculates the positive negative degree by the target identification section 901 (Step S2204). The response apparatus 200 determines whether or not the absolute value of the positive negative degree is equal to or greater than the threshold by the target identification section 901 (Step S2205).

In a case in which the absolute value of the positive negative degree is not equal to or greater than the threshold (Step S2205: No), then the response apparatus 200 determines that the anger 423 that is the user feeling 402 indicating the maximum feeling intensity continues by the target identification section 901, and the process returns to Step S2204. In contrast, in a case in which the absolute value of the positive negative degree is equal to or greater than the threshold (Step S2205: Yes), then the response apparatus 200 determines that the anger 423 that is the user feeling 402 indicating the maximum feeling intensity continues by the target identification section 901, and the process returns to Step S2204.

In contrast, in a case in which the absolute value of the positive negative degree is equal to or greater than the threshold (Step S2205: Yes), the response apparatus 200 determines that the user feeling 402 has changed from the anger 423 to the joy 421 or the sadness 422, and determines whether or not the user feeling 402 is positive by the target identification section 901 (Step S2206). Specifically, the response apparatus 200 determines, for example, that the user feeling 402 is positive if the positive negative degree takes a positive value, and that the user feeling 402 is negative if the positive negative degree takes a negative value by the target identification section 901.

In a case in which the user feeling 402 is positive (Step S2206: Yes), then the response apparatus 200 refers to the first target identification table of FIG. 13 for determining that the user feeling 402 has changed from the anger 423 to the joy 421 and identifies the target 401 as the third party 103 (Step S2207) by the target identification section 901, and the process goes to Step S2004. Conversely, in a case in which the user feeling 402 is negative (Step S2206: No), then the response apparatus 200 refers to the first target identification table of FIG. 13. However, since the target 401 is either the user 101 or the interactive robot 102, the response apparatus 200 is unable to uniquely identify the target 401. Owing to this, the process goes to Step S2004.

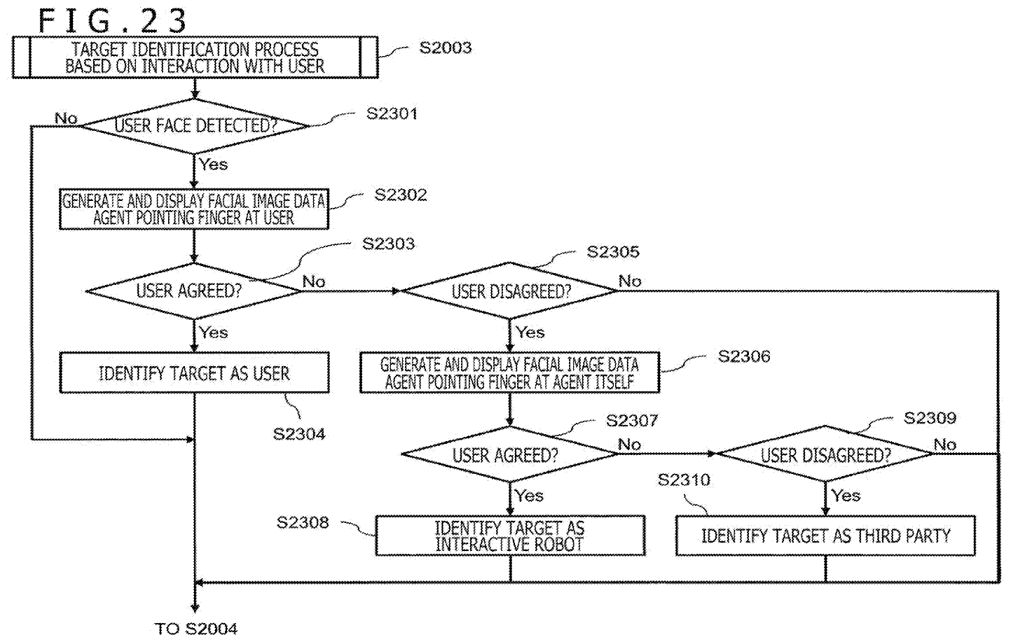

FIG. 23 is a flowchart indicating an example of a detailed process procedure of the [Target Identification Process Based on Interaction with User (2)]. The response apparatus 200 determines whether or not the response apparatus 200 has detected the face of the user 101 (Step S2301). Specifically, the response apparatus 200, for example, registers the facial image data 1501 on the user 101 in the storage device 302 in advance and collates the registered facial image data 1501 with the facial image data 1501 on the user 101 captured by the camera 201. The response apparatus 200 determines whether or not the response apparatus 200 has detected the face of the user 101 on the basis of a collation result.

In a case in which the response apparatus 200 has not detected the face of the user 101 (Step S2301: No), the process goes to Step S2004 without identifying the target 401. In contrast, in a case in which the response apparatus 200 has detected the face of the user 101 (Step S2301: Yes), the response apparatus 200 generates the facial image data on the agent 230 indicating finger pointing at the user 101 and displays the facial image of the agent 230 indicating finger pointing at the user 101 on the display device 203 (Step S2302).

Next, the response apparatus 200 determines whether or not the user 101 has agreed on the basis of the biological data acquired from the acquisition device 310 by the target identification section 901 (Step S2303). Specifically, the response apparatus 200 determines whether or not the user reaction 1402 depicted in FIG. 14 indicates agreement by the target identification section 901.

In a case in which the user 101 has agreed (Step S2303: Yes), then the response apparatus 200 identifies the target 401 as the user 101 by the target identification section 901 (Step S2304), and the process goes to Step S2004.

In a case in which the user 101 has not agreed (Step S2303: No), the response apparatus 200 determines whether or not the user 101 has disagreed on the basis of the biological data acquired from the acquisition device 310 by the target identification section 901 similarly to Step S2303 (Step S2305). Specifically, the response apparatus 200 determines whether or not the user reaction 1402 depicted in FIG. 14 indicates disagreement by the target identification section 901.

In a case in which the user 101 has not disagreed (Step S2305: No), the process goes to Step S2004 without identifying the target 401. In a case in which the user 101 has disagreed (Step S2305: Yes), the response apparatus 200 generates the facial image data on the agent 230 indicating finger pointing at the agent 230 itself and displays the facial image of the agent 230 indicating finger pointing at the agent 230 itself on the display device 203 by the target identification section 901 (Step S2306). The response apparatus 200 then determines whether the user 101 has agreed on the basis of the biological data acquired from the acquisition device 310 by the target identification section 901 similarly to Step S2303 (Step S2307).

In a case in which the user 101 has agreed (Step S2307: Yes), then the response apparatus 200 identifies the target 401 as the interactive robot 102 by the target identification section 901 (Step S2308), and the process goes to Step S2004.

In a case in which the user 101 has not agreed (Step S2307: No), then the response apparatus 200 determines whether or not the user 101 has disagreed on the basis of the biological data acquired from the acquisition device 310 by the target identification section 901 similarly to Step S2303 (Step S2309).

In a case in which the user 101 has not disagreed (Step S2309: No), the process goes to Step S2004 without identifying the target 401. In a case in which the user 101 has disagreed (Step S2309: Yes), then the response apparatus 200 identifies the target 401 as the third party 103 by the target identification section 901 (Step S2310), and the process goes to Step S2004.

(1) In this way, the response apparatus 200 in the present embodiment identifies the feeling expression target 401 of the user 101; identifies the user feeling 402; determines the feeling indicated by the facial image of the agent 230 on the basis of the target 401 and the user feeling 402; and generates facial image data on the agent 230 indicating the determined feeling and displays the facial image of the agent 230 on the display device 203. It is thereby possible to achieve an improvement in accuracy for a response to the user 101.

(2) Furthermore, in (1), the response apparatus 200 may identify the feeling expression target 401 of the user 101 by identifying the face direction 1001 of the user 101 from the facial image data 1501 on the user 101. It is thereby possible to estimate a companion faced by the user 101 as the feeling expression target 401 of the user 101.

(3) Moreover, in (1), the response apparatus 200 may identify the feeling expression target 401 of the user 101 by identifying the line-of-sight direction 1002 of the user 101 from the facial image data 1501 on the user 101. It is thereby possible to estimate a companion to which the user 101 turns the user's eyes as the feeling expression target 401 of the user 101.

(4) Furthermore, in (1), the response apparatus 200 may identify the feeling expression target 401 of the user 101 by identifying the finger pointing direction 1003 of the user 101 from the image data on the hand of the user 101. It is thereby possible to estimate a companion at which the user 101 is pointing a finger as the feeling expression target 401 of the user 101.

(5) Moreover, in (1), the response apparatus 200 may identify the feeling expression target 401 of the user 101 on the basis of the voice data on the user 101. It is thereby possible to estimate a companion to which the user 101 is talking as the feeling expression target 401 of the user 101.

(6) Furthermore, in (1), the response apparatus 200 may identify the feeling expression target 401 of the user 101 on the basis of the change in the user feeling 402. It is thereby possible to identify the feeling expression target 401 of the user 101 as the third party 103 if the user feeling 402 after the change is positive.

(7) Moreover, in (6), the response apparatus 200 may calculate the positive negative degree that indicates the change in the user feeling 402, and identify the feeling expression target 401 of the user 101 on the basis of the positive negative degree. It is thereby possible to digitize the change in the user feeling 402 and, therefore, achieve an improvement in target identification accuracy.

(8) Furthermore, in (7), the response apparatus 200 may identify the feeling expression target 401 of the user 101 as the third party 103 in a case in which the user feeling 402 before the change is the anger 423 and the user feeling 402 after the change in the positive negative degree is positive. It is thereby possible to identify the feeling expression target 401 of the user 101 as the third party 103 in the case in which the user feeling 402 is the anger 423 and the user reaction 1301 is positive when the interactive robot 102 imitates the user feeling 402 (anger 423).

(9) Moreover, in (1), the response apparatus 200 may identify the feeling expression target 401 of the user 101 as either the user 101 or the interactive robot 102 on the basis of the user reaction 1402 acquired by the acquisition device 310 as a result of display of the facial image of the agent 230 indicating finger pointing at the user 101 or the agent 230 itself on the display device 203. It is thereby possible to identify the feeling expression target 401 of the user 101 by a dialog between the user 101 and the interactive robot 102.

(10) Furthermore, in (1), the response apparatus 200 may determine the feeling indicated by the facial image of the agent 230 displayed on the display device 203 on the basis of the gender of the user 101. It is thereby possible to determine the feeling indicated by the facial image of the agent 230 in the light of a difference in gender.

While the feeling is expressed with the image of only the face of the agent 230 in the embodiment described above, the image is not limited to the facial image but may be an image of a humanoid robot and the feeling such as the anger, the surprise, the sadness, or the joy may be expressed by a motion or an action of the humanoid robot.

The present invention is not limited to the embodiment described above but encompasses various modifications and equivalent configurations within the meaning of the accompanying claims. For example, the above-mentioned embodiments have been described in detail for describing the present invention in order to facilitate easy understanding of the present invention, and the present invention is not always limited to the embodiment having all the described configurations. Furthermore, part of the configurations of a certain embodiment may be replaced by configurations of another embodiment. Moreover, the configurations of another embodiment may be added to the configurations of the certain embodiment. Further, for part of the configurations of each embodiment, addition, deletion, or replacement may be made of the other configurations.

Moreover, part of or all of the configurations, the functions, the processing sections, processing means, and the like described above may be realized by hardware by being designed, for example, as an integrated circuit, or may be realized by software by causing the processor to interpret and execute programs that realize the functions.

Information in programs, tables, files, and the like for realizing the functions can be stored in a storage device such as a memory, a hard disk, or a solid state drive (SSD), or in a recording medium such as an integrated circuit (IC) card, a secure digital (SD) card, or a digital versatile disc (DVD).

Furthermore, control lines or information lines considered to be necessary for the description are illustrated and all the control lines or the information lines necessary for implementation are not always illustrated. In practice, it may be considered that almost all the configurations are mutually connected.

What is claimed is:

1. A response apparatus comprising:
a processor that executes a program; and
a storage device that stores the program, and the response apparatus being connected to an acquisition device that acquires biological data and a display device that displays an image, wherein the processor executes:
a target identification process that identifies a feeling expression target of a user using the response apparatus on a basis of the biological data on the user acquired by the acquisition device;
a feeling identification process that identifies a feeling of the user on a basis of facial image data on the user;
a determination process that determines a feeling indicated by the image displayed on the display device on a basis of the feeling expression target identified by the target identification process and the feeling of the user identified by the feeling identification process; and
a generation process that generates image data indicating the feeling determined by the determination process to output the image data to the display device.

2. The response apparatus according to claim 1, wherein
in the target identification process, the processor identifies the feeling expression target of the user by identifying an orientation of a face of the user on the basis of the facial image data on the user in a case in which the biological data is the facial image data on the user.

3. The response apparatus according to claim 1, wherein
in the target identification process, the processor identifies the feeling expression target of the user by identifying a line-of-sight direction of the user on the basis of the facial image data on the user in a case in which the biological data is the facial image data on the user.

4. The response apparatus according to claim 1, wherein
in the target identification process, the processor identifies the feeling expression target of the user by identifying a finger pointing direction of the user on a basis of image data on a hand of the user in a case in which the biological data is the image data on the hand of the user.

5. The response apparatus according to claim 1, wherein
in the identification process, the processor identifies the feeling expression target of the user on a basis of at least voice data on the user in a case in which the biological data includes the voice data on the user.

6. The response apparatus according to claim 1, wherein
in the target identification process, the processor identifies the feeling expression target of the user on a basis of a change in the feeling of the user.

7. The response apparatus according to claim 6, wherein
in the target identification process, the processor calculates an evaluation value that indicates the change in the feeling of the user, and identifies the feeling expression target of the user on a basis of the evaluation value.

8. The response apparatus according to claim 7, wherein
in the target identification process, the processor identifies the feeling expression target of the user as a third party in a case in which the feeling of the user before the change is anger and the evaluation value is a value that affirms the feeling of the user after the change.

9. The response apparatus according to claim 1, wherein
in the target identification process, the processor identifies the feeling expression target of the user as either the user or the response apparatus on a basis of reaction data on the user to an image that indicates finger pointing at the user or the response apparatus and that is acquired by the acquisition device as a result of display of the image that indicates the finger pointing by the display device.

10. The response apparatus according to claim 1, wherein
in the determination process, the processor determines the feeling indicated by the image displayed on the display device on a basis of a gender of the user.

11. A response method executed by a response apparatus including a processor that executes a program and a storage device that stores the program, the response apparatus being connected to an acquisition device that acquires biological data and a display device that displays an image, the response method causing the processor to execute:
a target identification process that identifies a feeling expression target of a user using the response apparatus on a basis of the biological data on the user acquired by the acquisition device;
a feeling identification process that identifies a feeling of the user on a basis of facial image data on the user;
a determination process that determines a feeling indicated by the image displayed on the display device on a basis of the feeling expression target identified by the target identification process and the feeling of the user identified by the feeling identification process; and
a generation process that generates image data indicating the feeling determined by the determination process to output the image data to the display device.
